(19) United States
(12) Patent Application Publication
(10) Pub. No.: US 2026/0344682 A1
(43) Pub. Date: Nov. 5, 2026

(54) DUMPLING MAKING DEVICE

(71) Applicant: Terry Steven, Niles, MI (US)

(72) Inventor: Terry Steven, Niles, MI (US)

(21) Appl. No.: 19/194,814

(22) Filed: Apr. 30, 2025

(51) Int. Cl. A21C 11/16; A21C 11/10; B26D 1/02

(52) U.S. Cl. CPC A21C 11/16; A21C 11/106; B26D 1/02

(57) ABSTRACT

A dumpling making device for extruding and cutting dumplings includes a tubular housing having an interior space for holding a dough. A lid covers a top end of the housing and an end cap is positioned at a bottom end of the housing. The end cap secures an extrusion plate on the housing. A push plate is movable within the housing for pushing the dough towards and through an opening in the extrusion plate. A threaded shaft extends through the housing and engages the push plate. A crank handle is coupled to the shaft and extends from the lid. A blade is positioned between the extrusion plate and the end cap. A tab extends from the shaft and engages the blade such that rotation of the shaft rotates the blade. The blade passes over the opening to shear through the dough passed through the opening.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to food making devices and more particularly pertains to a new food making device for extruding and cutting dumplings.

### (2) Description of Related Art Including Information Disclosed Under 37 CFR 1.97 and 1.98.

The prior art relates to food making devices. Known prior art lacks a hand turned handle to extrude and cut dumplings.

### (H) BRIEF SUMMARY OF THE INVENTION

An embodiment of the disclosure meets the needs presented above by generally comprising a tubular housing having an interior space for holding a dough. A lid covers a top end of the housing and an end cap is positioned at a bottom end of the housing. The end cap secures an extrusion plate on the housing. A push plate is movable within the housing for pushing the dough towards and through an opening in the extrusion plate. A threaded shaft extends through the housing and engages the push plate. A crank handle is coupled to the shaft and extends from the lid. A blade is positioned between the extrusion plate and the end cap. A tab extends from the shaft and engages the blade such that rotation of the shaft rotates the blade. The blade passes over the opening to shear through the dough passed through the opening.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a dumpling making device according to an embodiment of the disclosure.

FIG. 2 is a perspective view of an embodiment of the disclosure.

FIG. 3 is a partially exploded perspective view of an embodiment of the disclosure.

FIG. 4 is a partially exploded perspective view of an embodiment of the disclosure.

FIG. 5 is a perspective view of an embodiment of the disclosure.

FIG. 6 is a perspective view of an embodiment of the disclosure in use.

### (J) DETAILED DESCRIPTION OF THE INVENTION

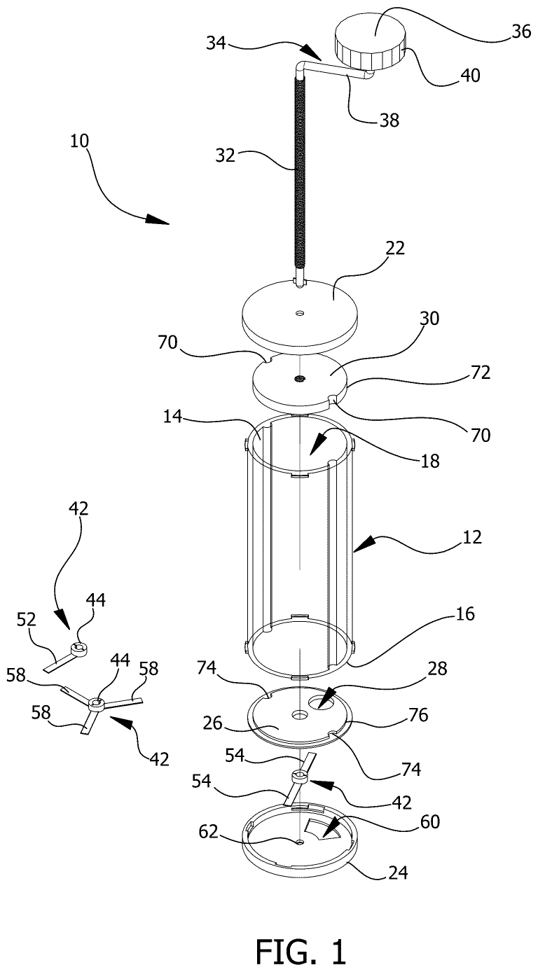

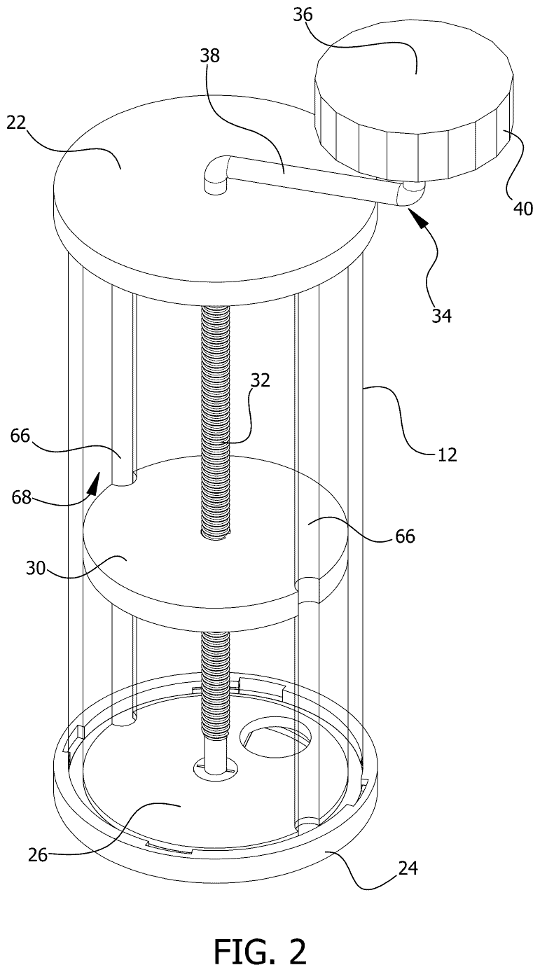

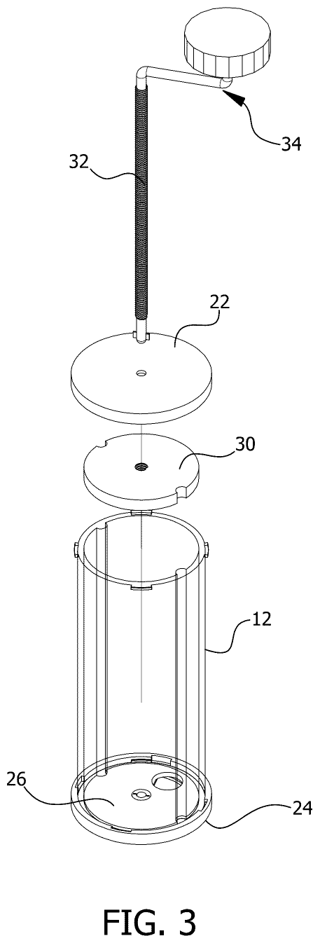

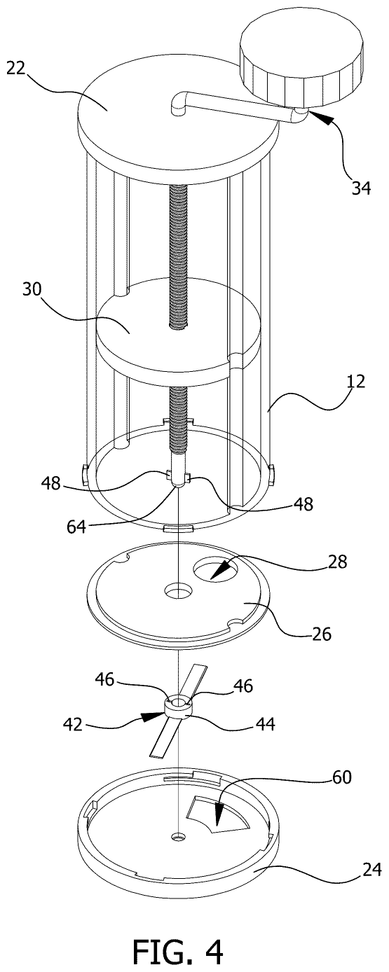

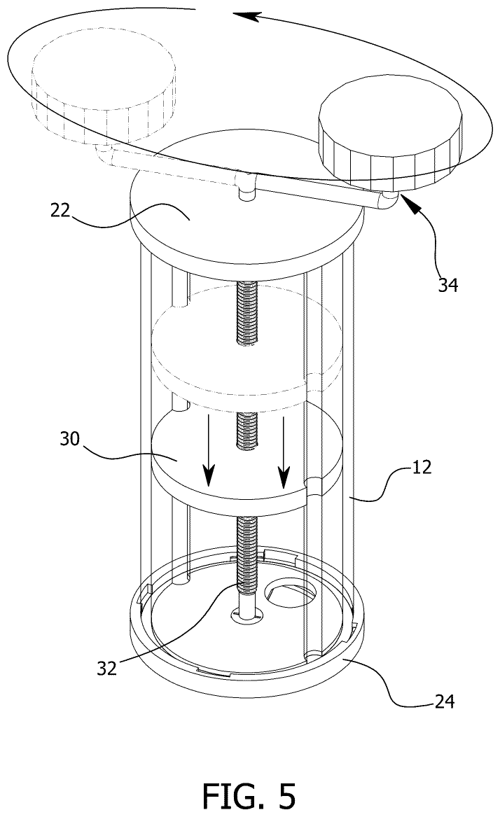

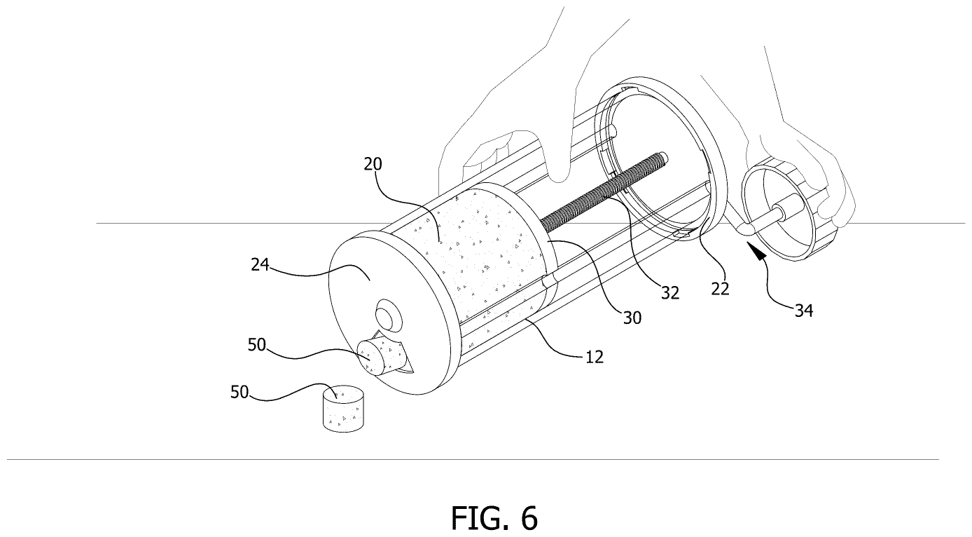

With reference now to the drawings, and in particular to FIGS. 1 through 6 thereof, a new food making device embodying the principles and concepts of an embodiment of the disclosure and generally designated by the reference numeral 10 will be described.

As best illustrated in FIGS. 1 through 6, the dumpling making device 10 generally comprises a housing 12 having a top end 14 and a bottom end 16. The top end 14 is open and the bottom end 16 is also open such that the housing 12 is tubular. An interior space 18 of the housing 12 is configured for holding a dough 20 for dumplings or the like. A lid 22 is couplable to the housing 12 covering the top end 14. An end cap 24 is couplable to the housing 12 positioned at the bottom end 16 of the housing 12. An extrusion plate 26 is positionable at the bottom end 16 of the housing 12. The end cap 24 secures the extrusion plate 26 at the bottom end 16 of the housing 12. The extrusion plate 26 has an opening 28 for passing the dough 20 through the opening 28. As should be understandable without specific showing in the drawing figures, the extrusion plate 26 may be one of multiple extrusion plates of similar size and shape but for the size of the opening 28. This allows for interchanging of extrusion plates 26 to select a desired size for the opening 28.

A push plate 30 is positioned within the housing 12. The push plate 30 is movable within the housing 12 for pushing the dough 20 towards and through the opening 28 in the extrusion plate 26. A shaft 32 extends through the housing 12. The shaft 32 is threaded and engages the push plate 30 wherein rotation of the shaft 32 urges the push plate 30 to move between the top end 14 and the bottom end 16 of the housing 12. Reversing direction of rotation of the shaft 32 reverses direction of movement of the push plate 30 within the housing 12. A crank handle 34 is coupled to the shaft 32. The crank handle 34 extends from the lid 22. The crank handle 34 has a grip 36 rotatably coupled to an offset arm 38. The grip 36 is disk shaped having a circular outer peripheral wall 40. The offset arm 38 positions the grip 36 offset from a center of rotation of the shaft 32 such that turning the crank handle 34 rotates the shaft 32.

A blade 42 is positioned between the extrusion plate 26 and the end cap 24. The blade 42 has a hub 44. The hub 44 has a pair of slits 46. Each of a pair of tabs 48 is coupled to and extends from the shaft 32. The tabs 48 are diametrically opposed. Each of the tabs 48 is positioned to engage the hub 44 of the blade 42 wherein rotation of the shaft 32 rotates the blade 42. The blade 42 passes over the opening 28 wherein the blade 42 is configured to shear through the dough 20 passed through the opening 28 separating portions of the dough 20 into separate dumplings 50. Each tab 48 engages the hub 44 of the blade 42 such that rotation of the shaft 32 rotates the blade 42. The blade 42 may have a single cutting edge 52 extending from the hub 44 or a pair of cutting edges 54 extending from the hub 44. The pair of cutting edges 54 are diametrically opposed across the hub 44 to produce equally sized dumplings 50 approximately half the size of using a blade 42 having the single cutting edge 52. It is contemplated that the blade 42 may have three cutting edges 58 extending from the hub 44. The three cutting edges 58 are evenly spaced and radially arranged around the hub 44 to produce equal sized dumplings 50 approximately a third the size of using the single cutting edge 52. Additional numbers of cutting edges may be incorporated into a blade 42.

The end cap 24 has an aperture 60. The aperture 60 is larger than and positioned relative to the opening 28 in the extrusion plate 36 such that the aperture 60 is configured to let dough 20 sheared by the blade 42 pass through the aperture 60. The end cap 24 has a seat 62. The seat 62 receives a terminal end 64 of the shaft 32. The terminal end 64 of the shaft 32 rotates in the seat 62 when the shaft 32 is rotated. Each of a pair of rails 66 extends along an interior surface 68 of the housing 12 between the top end 14 and the bottom end 16. Each rail 66 is engaged by an associated one of a pair of push guide notches 70 in a peripheral edge 72 of the push plate 30 wherein the push plate 30 is inhibited from rotating with the shaft 32 and rotation of the shaft 32 urges the push plate 30 to move along the rails 66 within the housing 12. Each rail 66 also engages an associated one of a pair of guide notches 74 in a perimeter edge 76 of the extrusion plate 26 wherein the extrusion plate 26 is inhibited from rotation with the shaft 32 and the opening 28 in the extrusion plate 26 remains aligned with the aperture 60 in the end cap 24.

In use, the desired extrusion plate 26 is positioned on the bottom end 16 of the housing 12 and secured by the end cap 24 with a desired blade 42 positioned between the extrusion plate 26 and the end cap 24. The dough 20 is positioned in the housing 12. The lid 22 is secured to the top end 14 of the housing 12 with the dough 20 being positioned between the push plate 30 and the extrusion plate 26. The crank handle 34 is rotated to move the push plate 30 within the housing 12 forcing the dough 20 through the opening 28. Rotation of the blade 42 shears the dough 20 to produce the separate dumplings 50. The dumplings 50 will be of equal and consistent size for uniformity in cooking time.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dumpling making device comprising:
a housing having a top end and a bottom end, said top end being open, said bottom end being open such that said housing is tubular, an interior space of said housing being configured for holding a dough;
a lid couplable to said housing, said lid covering said top end;
an end cap couplable to said housing, said end cap being positioned at said bottom end of said housing;
an extrusion plate positionable at said bottom end of said housing, said end cap securing said extrusion plate at said bottom end of said housing, said extrusion plate having an opening wherein said extrusion plate is configured for passing the dough through the opening;
a push plate positioned within said housing, said push plate being movable within said housing wherein said push plate is configured for pushing the dough towards and through the opening in the extrusion plate;
a shaft extending through said housing, said shaft being threaded and engaging said push plate wherein rotation of said shaft urges said push plate to move between said top end and said bottom end of said housing;
a crank handle, said crank handle being coupled to said shaft, said crank handle extending from said lid;
a blade positioned between said extrusion plate and said end cap; and
a tab coupled to and extending from said shaft, said tab being positioned to engage said blade wherein rotation of said shaft rotates said blade, said blade passing over said opening wherein said blade is configured to shear through the dough passed through the opening.

2. The dumpling making device of claim 1, further comprising said tab being one of a pair of diametrically opposed tabs.

3. The dumpling making device of claim 1, further comprising said end cap having an aperture, said aperture being larger than and positioned relative to said opening in said extrusion plate such that said aperture is configured to let dough sheared by said blade pass through said aperture.

4. The dumpling making device of claim 1, further comprising:
a pair of rails extending along an interior surface of said housing between said top end and said bottom end; and
a pair of push guide notches in a peripheral edge of said push plate, each of said rails engaging an associated one of said push guide notches wherein said push plate is inhibited from rotating with said shaft.

5. The dumpling making device of claim 4, further comprising a pair of guide notches in a perimeter edge of said extrusion plate, each of said rails engaging an associated one of said guide notches wherein said extrusion plate is inhibited from rotation with said shaft and said opening in said extrusion plate remains aligned with said aperture in said end cap.

6. The dumpling making device of claim 1, further comprising said blade having a hub, said tab engaging said hub of said blade wherein rotation of said shaft rotates said blade.

7. The dumpling making device of claim 6, further comprising said blade having a single cutting edge extending from said hub.

8. The dumpling making device of claim 6, further comprising said blade having a pair of cutting edges extending from said hub, said pair of cutting edges being diametrically opposed across said hub.

9. The dumpling making device of claim 6, further comprising said blade having three cutting edges extending from said hub, said three cutting edges being evenly spaced and radially arranged around said hub.

10. The dumpling making device of claim 1, further comprising a said crank handle having grip rotatably coupled to an offset arm.

11. The dumpling making device of claim 10, further comprising said grip being disk shaped having a circular outer peripheral wall.

12. The dumpling making device of claim 1, further comprising said end cap having a seat, said seat receiving a terminal end of said shaft, said terminal end of said shaft rotating in said seat when said shaft is rotated.

13. A dumpling making device comprising:
a housing having a top end and a bottom end, said top end being open, said bottom end being open such that said housing is tubular, an interior space of said housing being configured for holding a dough;
a lid couplable to said housing, said lid covering said top end;
an end cap couplable to said housing, said end cap being positioned at said bottom end of said housing;
an extrusion plate positionable at said bottom end of said housing, said end cap securing said extrusion plate at said bottom end of said housing, said extrusion plate having an opening wherein said extrusion plate is configured for passing the dough through the opening;
a push plate positioned within said housing, said push plate being movable within said housing wherein said push plate is configured for pushing the dough towards and through the opening in the extrusion plate;
a shaft extending through said housing, said shaft being threaded and engaging said push plate wherein rotation of said shaft urges said push plate to move between said top end and said bottom end of said housing;
a crank handle, said crank handle being coupled to said shaft, said crank handle extending from said lid, said crank handle having grip rotatably coupled to an offset arm, said grip being disk shaped having a circular outer peripheral wall;
a blade positioned between said extrusion plate and said end cap, said blade having a hub;
a pair of tabs coupled to and extending from said shaft, said tabs being diametrically opposed, each of said tabs being positioned to engage said blade wherein rotation of said shaft rotates said blade, said blade passing over said opening wherein said blade is configured to shear through the dough passed through the opening, each said tab engaging said hub of said blade wherein rotation of said shaft rotates said blade;
said end cap having an aperture, said aperture being larger than and positioned relative to said opening in said extrusion plate such that said aperture is configured to let dough sheared by said blade pass through said aperture, said end cap having a seat, said seat receiving a terminal end of said shaft, said terminal end of said shaft rotating in said seat when said shaft is rotated;
a pair of rails extending along an interior surface of said housing between said top end and said bottom end;
a pair of push guide notches in a peripheral edge of said push plate, each of said rails engaging an associated one of said push guide notches wherein said push plate is inhibited from rotating with said shaft; and
a pair of guide notches in a perimeter edge of said extrusion plate, each of said rails engaging an associated one of said guide notches wherein said extrusion plate is inhibited from rotation with said shaft and said opening in said extrusion plate remains aligned with said aperture in said end cap.

14. The dumpling making device of claim 13, further comprising said blade having a single cutting edge extending from said hub.

15. The dumpling making device of claim 13, further comprising said blade having a pair of cutting edges extending from said hub, said pair of cutting edges being diametrically opposed across said hub.

16. The dumpling making device of claim 13, further comprising said blade having three cutting edges extending from said hub, said three cutting edges being evenly spaced and radially arranged around said hub.
